(19) United States
(12) Patent Application Publication
(10) Pub. No.: US 2026/0349755 A1
(43) Pub. Date: Nov. 5, 2026

(54) REAL-TIME AI-BASED INTELLIGENT SCREEN RECORDING

(71) Applicant: Bank of America Corporation, Charlotte, NC (US)

(72) Inventors: Nipun Mahajan, Lawrenceville, NJ (US); Yogesh Raghuvanshi, Pennington, NJ (US); Veera Venkata Anand Madhireddy, Charlotte, NC (US); S. B. Pravin Kumar, Nagercoil (IN); Yazhini Chandran, Charlotte, NC (US); Amitt Mishra, Chennai (IN); Sabesan Venkataraman, Charlotte, NC (US)

(21) Appl. No.: 19/198,741

(22) Filed: May 5, 2025

(51) Int. Cl. G06F 9/451; H04L 51/216

(52) U.S. Cl. CPC G06F 9/451; H04L 51/216

(57) ABSTRACT

A real-time artificial intelligence (AI)-based intelligent screen recording system is provided. The system may identify contexts of conversations between customer service center agents and their customers. The system may map one or more SORs to each of the conversations based on the identified contexts. The system may pop up links to SORs to screens, through which the customer service center agents are having the conversations with their customers. The system may differentiate each conversation and corresponding SOR(s) shown on the customer service center agents' computing device screens by applying different colored overlays. The system may record one or more of the conversations and corresponding SORs based on the colored overlays.

### TECHNICAL FIELD

Generally, the present disclosure relates to a method, a computing platform, and a system for screen recording. More particularly, the present disclosure relates to a real-time artificial intelligence (AI)-based intelligent screen recording system.

### BACKGROUND

Conversations made between agents of a customer service or call center (e.g., an organization's customer service center) and their customers are required to be recorded for auditing and quality assurance purposes. For example, customer service center agents may reference to systems of record (SORs) to enter and record data related to the conversations. Generally, an agent may often handle more than one conversation simultaneously. For example, an agent may rely on a multitude of desktop applications (e.g., more than 50 desktop applications) to serve the customers across various channels and businesses. An agent may switch among conversation windows and SOR windows in order to revert to customers' queries simultaneously or near simultaneously and record the conversations with the customers. This may complicate a recording of a screen at the agent's end. For example, recording of conversation transcripts is often combined with corresponding SORs to which the agent references. This may also cause mistakes that may lead to inaccurate recording and/or recording of unnecessary private data.

Examples described herein provide a real-time AI-based intelligent screen recording system capable of recording, in real-time, a screen at a customer service center agent computing device, who engages in concurrent conversations with one or more customers.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some examples, the present disclosure may provide a method for recording conversations of one or more agents of a customer service center during interactions with one or more customers of the customer service center. The method may include receiving, by a computing platform having one or more processors, one or more conversations between the one or more agents of the customer service center and the one or more customers of the customer service center; determining, for each conversation of the one or more conversations, a context of a respective conversation; mapping, based on the determined contexts of each conversation of the one or more conversations, each conversation of the one or more conversations to one or more systems of record (SORs); popping up one or more links to the mapped one or more SORs on computing device screens through which the one or more agents interact during the one or more conversations with the one or more customers; determining, for each conversation of the one or more conversations, a status of the respective conversation; generating, based on the determined status of each conversation of the one or more conversations, one or more colored overlays associated with each conversation; displaying the one or more links and corresponding conversations shown on the screens with the one or more colored overlays; and recording, based on the status of each conversation indicated by the colored overlay, the one or more conversations.

In some examples, the method may further include identifying an identity of each of the one or more conversations.

In some examples, the method may further include retrieving user interface (UI) sources from a database; converting UI sources written in different languages into one format; building, based on the converted UI sources in one format, a structure of a UI image for showing each of the one or more links to the mapped one or more SORs on the screens; and estimating a boundary of the structure of the UI image for showing each of the one or more links to the mapped one or more SORs on the screens.

In some examples, the method may further include distinguishing colors for the determined statuses of the one or more conversations; tracking events associated with the one or more agents; and generating, based on the distinguished colors and the tracked events, the one or more colored overlays.

In some examples, the method may further include highlighting the one or more links and corresponding conversations shown on the screens.

In some examples, the method may further include decomposing the one or more conversations into frames; and masking pixels of conversations, of the one or more conversations, whose statuses are inactive.

In some examples, the method may further include segregating the one or more conversations at frame level; and sequencing conversations, of the one or more conversations, whose statuses are active, to generate a video of each of the conversations.

In some examples, the present disclosure may provide a computing platform. The computing platform may include at least one processor, a communication interface communicatively coupled to the at least one processor, and memory storing computer-readable instructions that, when executed by the at least one processor, cause the computing platform to execute methods described herein.

In some examples, the present disclosure may provide a non-transitory computer-readable medium, having computer-executable instructions stored thereon, the computer-executable instructions, when executed by one or more processors of a computing platform, cause the computing platform to facilitate executing methods described herein.

### BRIEF DESCRIPTION OF THE DRAWINGS

The present disclosure is illustrated by way of example and not limited in the accompanying figures in which like reference numerals indicate similar elements and in which:

FIG. 1 illustrates an example of an overview of a real-time AI-based intelligent screen recording system and a customer service center according to some examples of the present disclosure;

FIG. 2 illustrates a schematic diagram of a real-time AI-based intelligent screen recording system for recording, in real-time, a screen at a customer service center agent's computing device according to some examples of the present disclosure;

FIGS. 3A, 3B, and 3C illustrate communications and/or steps in one or more example methods associated with recording, in real-time, a screen at a customer service center agent's computing device according to some examples of the present disclosure;

FIGS. 4A and 4B illustrate one or more example screens at a customer service center agent's computing device according to some examples of the present disclosure;

FIGS. 5A and 5B illustrate one or more example screens at a customer service center agent's computing device according to some examples of the present disclosure;

FIG. 6 is a schematic flowchart showing one or more example methods associated with recording, in real-time, a screen at a customer service center agent's computing device according to some examples of the present disclosure; and

FIG. 7 is a schematic flowchart showing one or more example methods associated with recording, in real-time, a screen at a customer service center agent's computing device according to some examples of the present disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The present disclosure provides a system that comprises one or more computing platforms for real-time AI-based intelligent recording of screens at customer service center agents' computing devices. One or more processors of the one or more computing platforms may be configured to identify contexts of conversations between customer service center agents and their customers. The one or more processors may be configured to identify an identity (ID) of each of the conversations. The one or more processors may be configured to map one or more SORs to each of the conversations based on the identified contexts. The one or more processors may be configured to pop up links to SORs to screens, through which the customer service center agents are having the conversations with their customers. The pop-up links may serve as automatic and dynamic suggestions for the customer service center agents so that the customer service center agents might not need to determine which SOR(s) to open for each of the conversations. The one or more processors may be configured to differentiate each conversation and corresponding SOR(s) shown on the customer service center agents' computing device screens by applying different colors, color codes and/or colored overlays. For example, active conversations and corresponding SORs may be marked with green overlays while inactive conversations and corresponding SORs may be marked with yellow overlays. The one or more processors may be configured to differentiate each conversation and corresponding SOR(s) based on other types of statuses.

The one or more processors may be configured to segregate the conversations and corresponding SORs at frame level (e.g., segregating the conversations and corresponding SORs into frames). The one or more processors may be configured to identify statuses of the conversations and corresponding SORs based on different colored overlays marked to each conversation and corresponding SOR(s). The one or more processors may be configured to mask pixels and/or blur pixels of conversations and corresponding SORs that are marked with yellow overlays (e.g., inactive conversations). The one or more processors may be configured to sequence conversations and corresponding SORs that are marked with green overlays (e.g., active conversations). For example, the one or more processors may be configured to sequence the active conversations and corresponding SORs to obtain a complete recording of each of the active conversations and corresponding SOR(s).

The one or more processors may be configured to conduct internal learning training to identify any possible mistakes that may be made during the processing of real-time AI-based intelligent screen recording, and accordingly, improve accuracy of future processing. For example, the one or more processors may observe whether the customer agents click and open the links to suggested SORs after the links are popped up to the agents' screens. The one or more processors may be configured to identify reasons (e.g., mis-mapping of SORs to conversations) why the customer service center agents did not click and open the links to SORs as suggested if the links are not clicked and opened. Based on the identified reasons, the one or more processors may be configured to change, correct, and/or tune algorithms for identifying contexts of conversations and/or for mapping SORs to the conversations based on the identified contexts.

The one or more processors may be configured to notify the customer service center agents if the identified reasons as to why the customer service center agents did not click and open the links to suggested SORs are due to agents' individual actions. The one or more processors may be configured to flag to a supervisor of the customer service center if the customer service center agents ignore the notification. For example, the one or more processors may be configured to capture the customer service center agents' actions (e.g., where and what the customer service center agents are clicking on their screens) to analyze the agent's behavior. The one or more processors may be configured to use an error action priority lookup mechanism to determine appropriate responses if errors happen on the customer service center agents' ends. The one or more processors may be configured to evaluate rules according to an organization's rule engine and determine whether to notify the customer service center agents and/or their supervisors.

The present disclosure provides one or more methods of real-time AI-based intelligent screen recording. The present disclosure provides one or more systems that include the one or more computing platforms for real-time AI-based intelligent screen recording and one or more customer service centers.

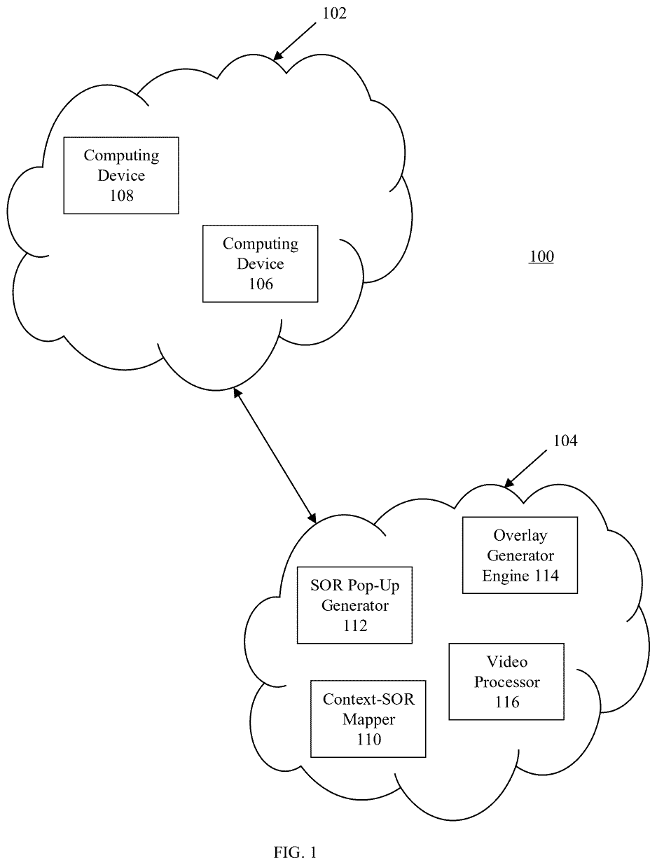

FIG. 1 illustrates an example of an overview computing environment 100 of a real-time AI-based intelligent screen recording system 104 and a customer service center 102. The customer service center 102 may include one or more computing devices, such as computing devices 106 and 108. Each agent of the customer service center 102 may revert to customers' queries via one of the one or more computing devices 106 or 108. In general, each customer service center agent may handle multiple conversations with multiple customers by switching between conversation windows shown on a screen or display of the computing device 106 or 108. Each customer service center agent may also switch between SOR windows for recording each of the multiple conversations. Each customer service center agent may engage in concurrent conversations with multiple customers via various channels, including phone calls, chat applications, text messages, and the like. Each agent may engage in concurrent conversations with multiple customers across lines of businesses. For example, in a financial institution's customer service center, conversations may relate to credit cards, debit cards, online banking, home mortgage loan, and the like.

Because a customer service center agent may operate multiple tabs in order to switch between conversation windows and reference to corresponding SORs for each conversation with their customers, chances of making mistakes may be high. Some of the customers may have similar queries (e.g., regarding credit cards), which may cause the customer service center agent to unnecessarily reference to multiple tabs on a same SOR. Accordingly, efficiency may be decreased and probability of making mistakes may be increased. In addition, a combination of recording of conversation transcripts and SORs corresponding to the conversations may complicate the operations at the customer service center agent's end. This may also become a source of mistakes, which may cause issues for an organization.

Examples of the present disclosure provide methods, apparatuses, and systems for real-time AI-based intelligent screen recording. For example, the real-time AI-based intelligent screen recording system 104 may include one or more computing platforms, such as computing platforms for context-SOR mapper 110, for SOR pop-up generator 112, for overlay generator engine 114, for video processor 116, and the like. Each of the computing platforms may include one or more processors for processing data for intelligent screening recording. The real-time AI-based intelligent screen recording system 104 may also include other types of computing platforms. Further, while each computing platform is shown separately in FIG. 1, in some examples, one or more computing platforms may be part of a single computing platform or device.

In general, the real-time AI-based intelligent screen recording system 104 may process context of each conversation between each customer service center agent and each of their customers in real-time. The real-time AI-based intelligent screen recording system 104 may identify SOR(s) that corresponds to the conversation and provide dynamic SOR(s) suggestion(s) to the customer service center agent. The real-time AI-based intelligent screen recording system 104 may differentiate multiple conversations between each customer service center agent and their customers and corresponding SOR(s) by applying color codes in real-time. Accordingly, the customer service center agent may see conversation windows and SOR windows more clearly on the screen of the computing device, through which they engage conversations with their customers. The real-time AI-based intelligent screen recording system 104 may also segregate the multiple conversations and corresponding SORs (e.g., active or inactive conversations and corresponding SORs) at frame level and then sequence them to a complete video recording of each conversation in real-time. Complete video recordings may be stored in an audit database for future use.

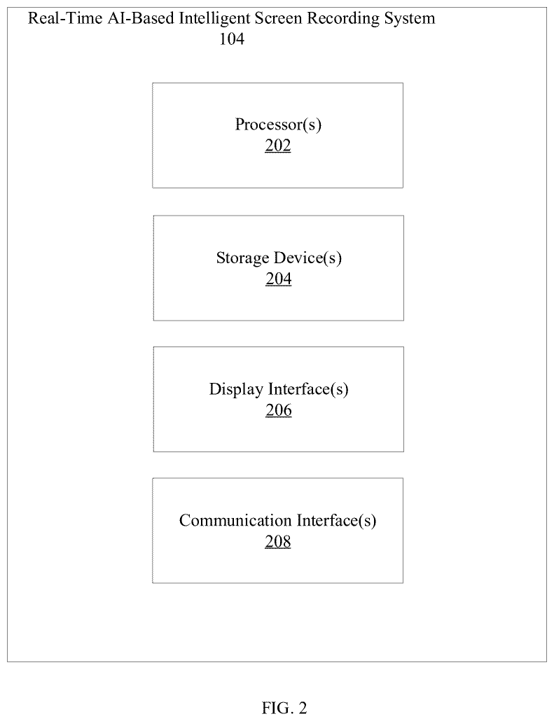

FIG. 2 illustrates a schematic diagram of a real-time AI-based intelligent screen recording system 104 for recording, in real-time, a screen at a customer service center agent's computing device. The real-time AI-based intelligent screen recording system 104 may include one or more processors 202, one or more storage devices 204 (e.g., memory), one or more display interfaces 206, one or more communication interfaces 208. The real-time AI-based intelligent screen recording system 104 may include other types of components.

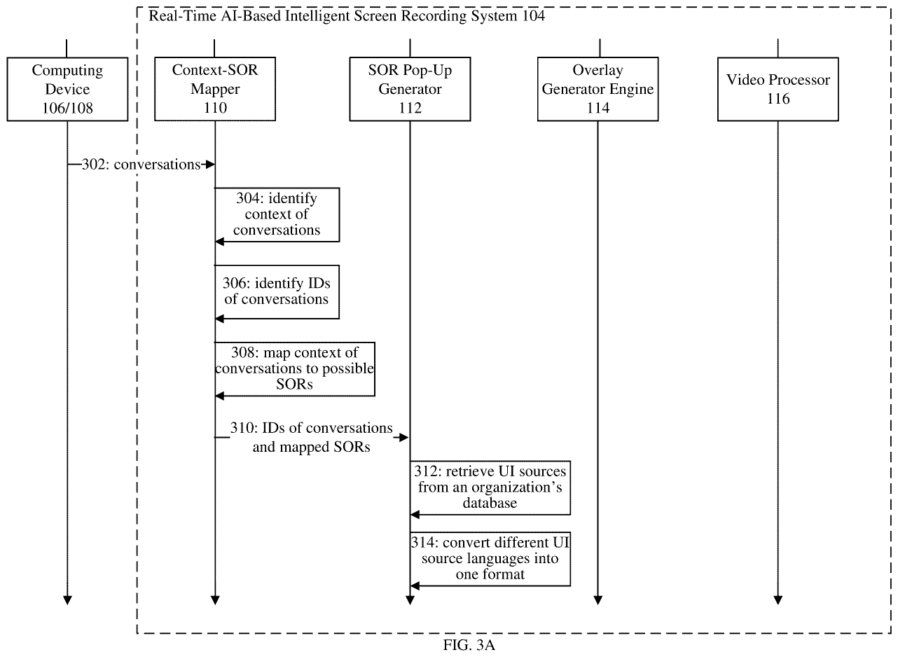

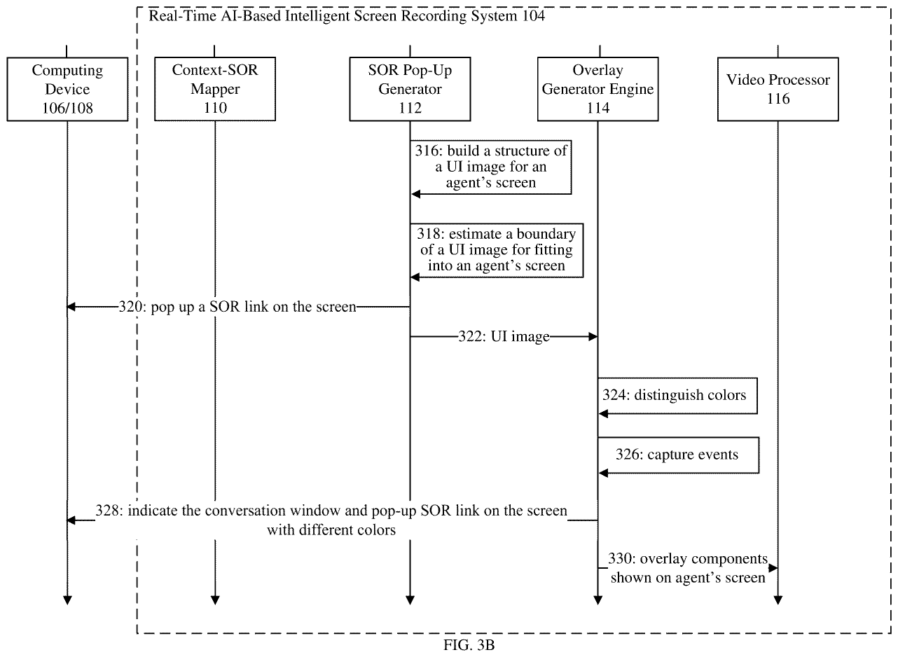

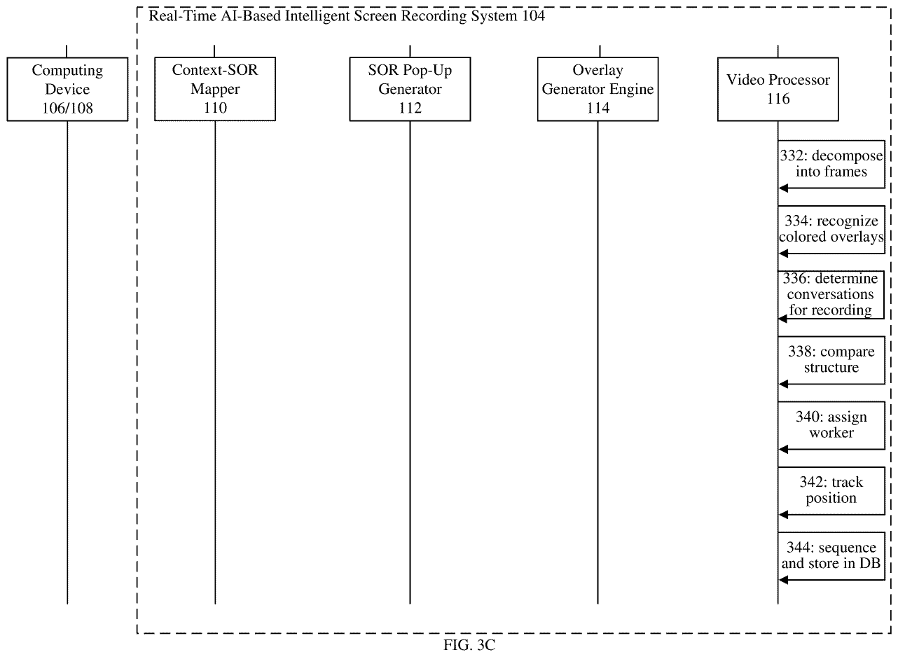

The display interface 206 and/or the one or more processors 202 may trigger the display interface 206 to display processing status at the real-time AI-based intelligent screen recording system 104, as shown in FIGS. 3A, 3B, 3C, 6, and 7. For example, the display interface 206 may display progress of mapping SORs to live conversations, generating links to the mapped SORs as suggestions for the customer service center agent, producing colored overlay components for indicating active and/or inactive conversations, and/or recording, as shown in FIGS. 3A, 3B, 3C, 6, and 7. Additionally and/or alternatively, the display interface 206 may display other types of information. Additionally and/or alternatively, the display interface 206 may be independent from the real-time AI-based intelligent screen recording system 104 (e.g., part of a user inputting device).

The one or more processors 202 may include one or more general-purpose processors, such as a central processing unit (CPU), or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The one or more storage devices 204 (e.g., memory) may include volatile memory, for example, random-access memory (RAM). The one or more storage devices 204 may further include non-volatile memory (NVM), for example, read-only memory (ROM), flash memory, hard disk drive (HDD), or solid-state drive (SSD). The one or more storage devices 204 may further include a combination of the foregoing types.

The one or more storage devices 204 (e.g., memory) may have computer-readable program codes stored thereon. The one or more processors 202 may read the computer-readable program codes stored on the memory 204 to perform the method described according to FIGS. 3A, 3B, 3C, 6, and 7. Additionally and/or alternatively, the one or more processors 202 may read the computer-readable program codes stored on the memory 204 to perform one or more other functions, or a combination of these functions.

The one or more processors 202 may further communicate with one or more other computing devices through the one or more communication interfaces 208. For example, the one or more processors 202 may further communicate with external physical memory or external memory on a cloud platform or a cloud infrastructure to retrieve data from a database and/or to store data on a database, as shown in step 344 of FIG. 3C.

A person of ordinary skill in the art will appreciate that the real-time AI-based intelligent screen recording system 104 as shown in FIG. 2 may communicate with one or more further computing devices through the one or more communication interfaces 208 or wireless connections for further functions, or a combination of functions. Further, the real-time AI-based intelligent screen recording system 104 as shown in FIG. 2 may also include one or more further functional components to perform and/or trigger further functions, or a combination of functions.

FIGS. 3A, 3B, and 3C illustrate communications and/or steps in one or more example methods associated with recording, in real-time, a screen at a customer service center agent's computing device. Although FIGS. 3A, 3B, and 3C show certain computing devices and/or computing platforms from FIGS. 1 and 2 as examples of computing devices and/or computing platforms that may perform one of more of the steps described below, one, some, or all of those steps may be performed by one or more other computing devices and/or computing platforms. The computing devices and computing platforms shown in FIGS. 3A, 3B, and 3C (and/or other computing devices) may be configured (e.g., based on stored instructions) to perform steps such as are described herein. One or more of the communications and/or steps shown in FIGS. 3A, 3B, and 3C may be rearranged, omitted, and/or otherwise modified, and/or other steps and/or communications added. A communication shown in, and/or described in connection with, FIGS. 3A, 3B, and 3C need not be a single message nor contained in a single packet, block, or other transmission unit.

With reference to FIG. 3A, at step 302, the computing device 106 (e.g., as shown in FIG. 1), through which a customer service center agent is handling conversations with one or more customers, may provide or send the conversations between the customer service center agent and the one or more customers to the context-SOR mapper 110 (e.g., as shown in FIG. 1) of the real-time AI-based intelligent screen recording system 104 (e.g., as shown in FIG. 1). For example, a computing device (e.g., a context handler) of the context-SOR mapper 110 may receive the conversations. Additionally and/or alternatively, the context-SOR mapper 110 may read or capture the conversations between the customer service center agent and the one or more customers shown on a screen of the computing device 106 (e.g., the customer center agent's screen). For example, a computing device (e.g., a context handler) of the context-SOR mapper 110 may read or capture the conversations from the screen of the computing device 106.

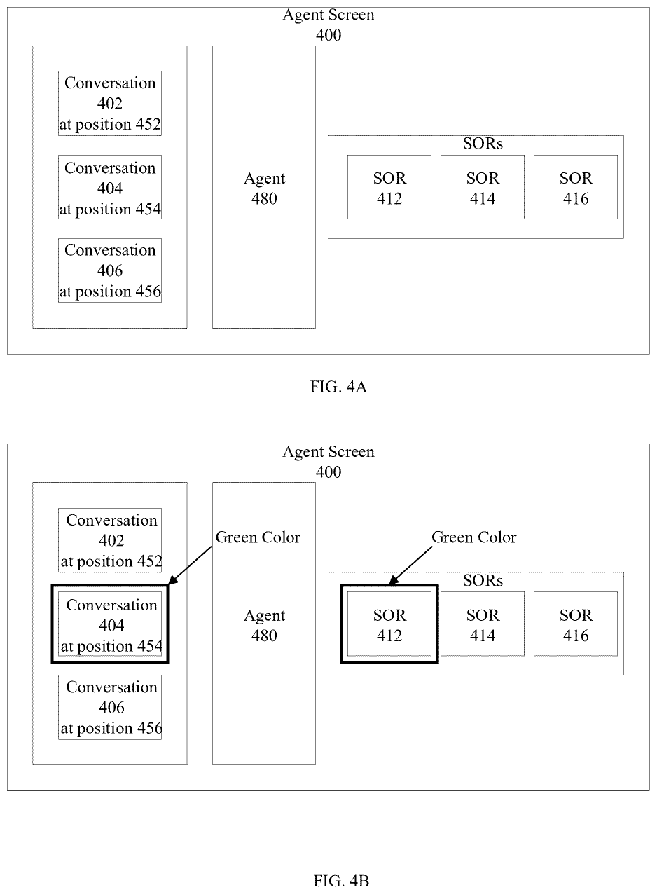

The conversations between the customer service center agent and the one or more customers may be shown on the screen of the computing device 106 that is operated by the customer service center agent (e.g., the customer service center agent's computing device screen or display), as shown in FIG. 4A. With reference to FIG. 4A, in one example, the customer service center agent's screen 400 (e.g., the screen or display of the computing device 106) may show that the customer agent 480 is handling three conversations, conversation 402 shown at a position 452 of the customer center agent's screen 400, conversation 404 shown at a position 454 of the customer center agent's screen 400, and conversation 406 shown at a position 456 of the customer service center agent's screen 400. Accordingly, the customer service center agent 480 may refer to three different SORs, SOR 412, SOR 414, and SOR 416, based on the topics of the three conversations, conversation 402, conversation 404, and conversation 406. For example, once a conversation (e.g., conversations 402, 404, or 406) starts, step 302 may be initiated, in which the computing device 106 may provide the conversation to the context handler of the context-SOR mapper 110, additionally and/or alternatively, the context handler of the context-SOR mapper 110 may read the conversation from the customer center agent's screen 400.

With further reference to FIG. 3A, in step 304, a computing device (e.g., a context identifier) of the context-SOR mapper 110 may identify context of each conversation. For example, a conversation may be initiated by a customer's query and a customer service center agent's corresponding answer that addresses the query. The conversation may continue if the customer asks more queries and the customer service center agent responds to these queries. The content identifier may extract contextual information from these queries and corresponding responses between the customer and the customer service center agent. The content identifier may further convert the contextual information into a vector for mapping a possible SOR to the conversation. In step 306, the context handler may identify a given identity (ID) of each conversation. In step 308, the context-SOR mapper 110 may map a possible SOR to each conversation based on corresponding context that is identified in step 304. With reference to FIG. 4A, in one example, conversation 402 may correspond to SOR 414, conversation 404 may correspond to SOR 412, and conversation 406 may correspond to SOR 416. Referring back to FIG. 3A, at step 310, the context-SOR mapper 110 may provide IDs of the conversations and SORs that are mapped to the conversations to the SOR pop-up generator 112 (e.g., as shown in FIG. 1) of the real-time AI-based intelligent screen recording system 104 (e.g., as shown in FIG. 1).

In step 312, a computing device (e.g., an intelligent style generator) of the SOR pop-up generator 112 may retrieve user interface (UI) sources from an organization's database to understand how to build links to the mapped SORs on the screen of the computing device 106 (e.g., the agent's screen 400 as shown in FIG. 4A) in a UI form. The organization's database may include webpages stored as UI sources, and the intelligent style generator may retrieve the webpages as images and/or as hypertext markup language (HTML) source codes. The organization's database may include other types of information related to UI sources. In step 314, the intelligent style generator of the SOR pop-up generator 112 may convert UI sources that are written in different languages into one format. As part of step 314, the intelligent style generator may uniformize different syntaxes of different UI sources that convey the same meaning.

With reference to FIG. 3B, in step 316, the intelligent style generator of the SOR pop-up generator 112 may lay out UI pages/images for links to the mapped SORs and identify or determine a structure for the UI pages/images based on understanding of the webpages retrieved from the organization's database. The UI pages/images may be a text, an image, a title, metadata, and/or a combination thereof that may provide the customer service center agent with a visual and contextual cue about where the links lead. As part of step 316, the intelligent style generator may generate a header, a body, a footer, and/or other elements for the UI pages/images for links to the mapped SORs. In step 318, the intelligent style generator of the SOR pop-up generator 112 may estimate a boundary of the UI pages/images for links to the mapped SORs so that the UI pages/images may fit into what is shown on the screen of the computing device 106. As part of step 318, the intelligent style generator may look for a position for putting the UI pages/images for links to the mapped SORs into all other information/windows shown on the screen of the computing device 106. The intelligent style generator may also adjust the position based on other windows (e.g., conversations windows and/or SOR windows) that are shown on the screen of the computing device 106.

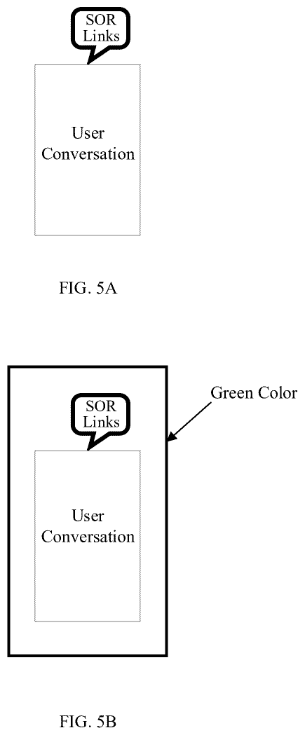

In step 320, the SOR pop-up generator 112 may pop up the UI pages/images for links to the mapped SORs (e.g., SOR links) on the screen of the computing device 106. For instance, SOR pop-up generator 112 may transmit or send the UI pages/images for links to the mapped SORs to the computing device 106, which may cause a pop-up interface to be displayed by the display of computing device 106. As shown in FIG. 5A, a pop-up SOR link is located on the top of the conversation window, through which the customer service center agent is answering their customers' queries. A size of the pop-up SOR link is smaller compared to that of the conversation window so that the pop-up SOR link might not affect the customer service center agent's view at the conversation window. The pop-up SOR link may serve as a suggestion to the customer service center agent so that the customer service center agent might not need to determine which SOR to refer to for each conversation with their customers.

Referring back to FIG. 3B, in step 322, the SOR pop-up generator 112 may provide the UI page/image for links to the mapped SORs to the overlay generator engine 114. In step 324, the overlay generator engine 114 may distinguish colors based on different status of each of the conversations between the customer service center agent and the one or more customers. In step 326, the overlay generator engine 114 may capture different events and/or activities at the customer service center agent's computing device 106. For example, the overlay generator engine 114 may identify where and what the customer service center agent is clicking. Accordingly, the overlay generator engine 114 may identify a mouse event associated with the customer service center agent. As part of step 326, the overlay generator engine 114 may determine that the customer service center agent is or is not actively engaging one conversation with one customer. Accordingly, the overlay generator engine 114 may provide a green color to the active conversation in step 324. The overlay generator engine 114 may provide a different color to another conversation in step 324 if the overlay generator engine 114 determines that the customer center agent is not actively engaging the other conversation with their customers in step 326.

In step 328, the overlay generator engine 114 may generate one colored overlay (e.g., a green overlay) for the active conversation window and corresponding pop-up SOR link. The overlay generator engine 114 may generate another colored overlay (e.g., a yellow overlay) for the inactive conversation window and corresponding pop-up SOR link. Accordingly, the overlay generator engine 114 may mark the active conversation window and corresponding pop-up SOR link with the green overlay for showing on the screen of the computing device 106. As shown in FIG. 5B, the overlay generator engine 114 may mark the active conversation window and corresponding pop-up SOR link with the green overlay for showing on the screen of the computing device 106. Likewise, the overlay generator engine 114 may mark the inactive conversation window and corresponding pop-up SOR link with the yellow overlay for showing on the screen of the computing device 106. This may provide the customer center agent with dynamic and automatic suggestions for SOR links that correspond to a conversation between the customer center agent and their customers. This may also draw attention of the customer service center's agent to SOR links that correspond to an active conversation between the customer service center agent and their customers. As such, it may become easier for the customer service center's agent to identify information and/or areas needing attention. Accordingly, possible manual mistakes on the customer service center agent's end may be reduced or avoided.

FIG. 4B shows another example customer service center agent's screen 400 after the overlay generator engine 114's processing in step 328. For example, the conversation 404 at the position 454 of the customer center agent's screen 400 may be active and marked with green overlay (e.g., highlighted with green color) while the conversation 402 and 406 may be inactive and shown as normal. Accordingly, SOR 412 may correspond to the conversation 404 and/or may be related to the conversation 404. The SOR 412 may be marked with green overlay (e.g., highlighted with green color).

In one example, the real-time AI-based intelligent screen recording system 104 may conduct an internal learning training based on whether the pop-up SOR links are clicked and opened by the customer service center agent. For example, the real-time AI-based intelligent screen recording system 104 may analyze and identify or determine reasons why the pop-up SOR links, which are suggested to the customer service center's agent, are not clicked and opened by the customer service center agent. It may be wrong suggestions for SOR links due to incorrect understanding of the conversation context, and accordingly, mismatch of the SOR links to the conversation. It may be that the customer service center agent might not want to click and open the suggested SOR links. It may be for some other reasons. The real-time AI-based intelligent screen recording system 104 may provide the analysis as feedback when context-SOR mapper 110 of the real-time AI-based intelligent screen recording system 104 processes future conversations received in step 302.

In one example, the real-time AI-based intelligent screen recording system 104 may send a notification to the customer service center agent if the real-time AI-based intelligent screen recording system 104 determines that the customer service center agent not clicking and opening the suggested SOR links is due to the customer service center agent's individual actions and/or errors. The real-time AI-based intelligent screen recording system 104 may flag the issue to a supervisor of the customer service center agent if the customer service center agent does not respond to the notification. For example, the real-time AI-based intelligent screen recording system 104 may capture mouse events associated with the customer service center agent (e.g., where and what the customer service center agent's mouse is clicking on their screen) to analyze the customer service center agent's behavior. The real-time AI-based intelligent screen recording system 104 may use an error action priority lookup mechanism to determine appropriate responses that are expected from a customer service center agent, and further, use an organization's rule engine to evaluate rules. Accordingly, the real-time AI-based intelligent screen recording system 104 may determine whether there are any errors on the customer service center agent's end.

In step 330, the overlay generator engine 114 may provide colored overlays or colored overlay components shown on the customer service center agent's screen (e.g., the screen of the computing device 106) to the video processor 116 of the real-time AI-based intelligent screen recording system 104. Accordingly, a screen recorder of the customer service center's screen may video record the content, including the colored overlays, shown on the customer service center's screen and generate video stream.

With reference to FIG. 3C, in step 332, the video processor 116 may decompose the video stream into frames to obtain multiple images of the video. In step 334, the video processor 116 may identify active and inactive conversations between the customer service center agent and the one or more customers based on the colored overlays. For example, the video processor 116 may identify the green overlay as an active conversation, and identify the yellow overlay as an inactive conversation. In step 336, the video processor 116 may determine to record the frames that correspond to the active conversation, for example, a computing device, such as a video segregator of the video processor 116, may record the frames corresponding to the active conversation and sequence them into one video for each active conversation. As part of step 336, the video processor 116 may mask and/or blur pixels of the frames that correspond to inactive conversations.

In step 338, the video segregator of the video processor 116 may compare a structure of all active conversation windows shown on the screen of the computing device 106 so that active conversation windows may be located and tracked for recording/sequencing. Accordingly, the video segregator of the video processor 116 may determine whether there is any change of the active conversation windows. For example, positions of the active conversation windows shown on the screen of the computing device 106 may remain if the number of active conversation windows remains. In this case, the video segregator will proceed with step 342. For example, positions of the active conversation windows shown on the screen of the computing device 106 may change if the number of active conversation windows changes (e.g., from 3 active conversation windows to 2 or 4 active conversation windows). In this case, the video segregator will proceed with step 340.

In step 342, the video segregator of the video processor 116 may track the positions of the active conversation windows and allocate one computing device or one software tool (e.g., a frame sequencer) to each of the active conversation windows. For example, frame sequencer 1 may collect all frames of an active conversation (e.g., conversation 402 shown in FIG. 4A) based on the position of the active conversation window shown on the agent's screen (e.g., position 452 shown on the agent's screen 400, as shown in FIG. 4A). Likewise, frame sequencer 2 may collect all frames of another active conversation (e.g., conversation 404 shown in FIG. 4A) based on the position of the active conversation window shown on the agent's screen (e.g., position 454 shown on the agent's screen 400, as shown in FIG. 4A). Frame sequencer 3 may collect all frames of another active conversation (e.g., conversation 406 shown in FIG. 4A) based on the position of the active conversation window shown on the agent's screen (e.g., position 456 shown on the agent's screen 400, as shown in FIG. 4A). In step 344, the video segregator may sequence the frames collected by the frame sequencer 1 into a first video and store it into an audit database. For example, the frame sequencer 1 may encode the frames in an order and combine them into a video file format. The video segregator may sequence the frames collected by the frame sequencer 2 into a second video and store it into the audit database. The video segregator may sequence the frames collected by the frame sequencer 3 into a third video and store it into the audit database. Step 342 may repeat after step 340.

In step 340, a computing device (e.g., a worker assigner of the video processor 116) may assign a new worker/a new frame sequencer to an active conversation window due to the change of the number of active conversation windows (e.g., from 3 active conversation windows to 2 or 4 active conversation windows), and accordingly, the change of the positions of the active conversation windows shown on the agent's screen. As part of step 340, the worker assigner may use optical character recognition (OCR) to read the content of the conversation shown on the agent's screen. The worker assigner may compare the content read by the OCR with the frames previously collected by the frame sequencer (e.g., the frame sequencer 1 for the conversation 402 at position 452 shown on the agent's screen 400, as shown in FIG. 4A) to determine whether there is a match. The worker assigner may adjust the frame sequencer, for example, the frame sequencer 1 from position 452 shown on the agent's screen 400 to position 456 shown on the agent's screen 400 for the same conversation with the same customer if there is a match in content. The worker assigner may assign a new worker/a new frame sequencer to collect images of a new active conversation if there is no match in content. As part of step 340, the worker assigner may monitor the active conversations. The worker assigner may also free some of the workers/frame sequencers if an active conversation becomes unavailable. Accordingly, the worker assigner may also assign the free worker/free frame sequencer to another active conversation at another position shown on the agent's screen. Additionally and/or alternatively, the worker assigner may also send a flush signal to a worker/frame sequencer to indicate that the conversation may not be available, and accordingly, collection of the images of the conversation may not be needed.

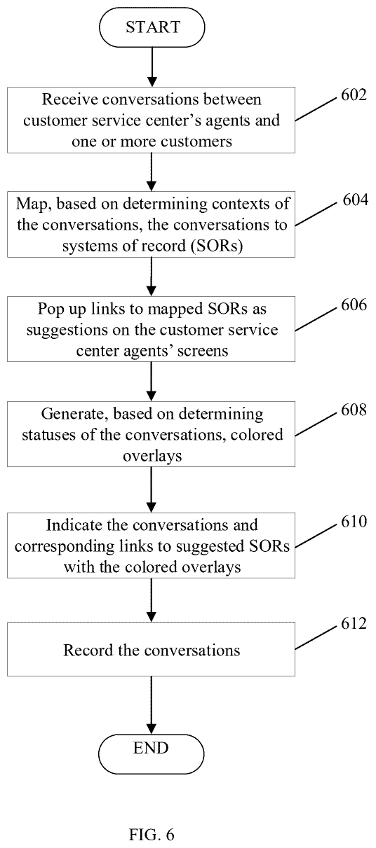

FIG. 6 is a schematic flowchart showing one or more example methods associated with recording, in real-time, a screen at a customer service center agent's computing device. The processing may comprise indicating each active conversation and corresponding links to mapped SORs on a customer service center agent's screen and video record each active conversation in real-time. Although various steps described by example of performance by certain computing platforms of the real-time AI-based intelligent screen recording system 104, one, some or all steps could be performed by one or more other computing platforms. One or more steps may be rearranged (e.g., performed in different order), omitted, or otherwise modified, and/or steps may be added.

In step 602, the context-SOR mapper 110 of the real-time AI-based intelligent screen recording system 104 (e.g., as shown in FIG. 1) may receive conversations between customer service center agents and one or more customers. Step 602 may, for example, comprise (or be comprised by) step 302 of FIG. 3A.

In step 604, the context-SOR mapper 110 may map, based on determining contexts of the conversations, SORs to the conversations. Step 604 may, for example, comprise (or be comprised by) step 308 of FIG. 3A.

In step 606, the SOR pop-up generator 112 of the real-time AI-based intelligent screen recording system 104 (e.g., as shown in FIG. 1) may pop up links to the mapped SORs on screens through which the customer service center agents make the conversations with their customers. Step 606 may, for example, comprise (or be comprised by) step 320 of FIG. 3B.

In step 608, the overlay generator engine 114 of the real-time AI-based intelligent screen recording system 104 (e.g., as shown in FIG. 1) may generate, based on determining statuses of the conversations, colored overlays. Step 608 may, for example, comprise (or be comprised by) step 328 of FIG. 3B.

In step 610, the overlay generator engine 114 of the real-time AI-based intelligent screen recording system 104 (e.g., as shown in FIG. 1) may indicate the links to the mapped SORs and corresponding conversations with colored overlays. Step 610 may, for example, comprise (or be comprised by) step 328 of FIG. 3B.

In step 612, the video processor 116 of the real-time AI-based intelligent screen recording system 104 (e.g., as shown in FIG. 1) may video record the conversations between the customer service center agents and their customers. Step 612 may, for example, comprise (or be comprised by) step 344 of FIG. 3C.

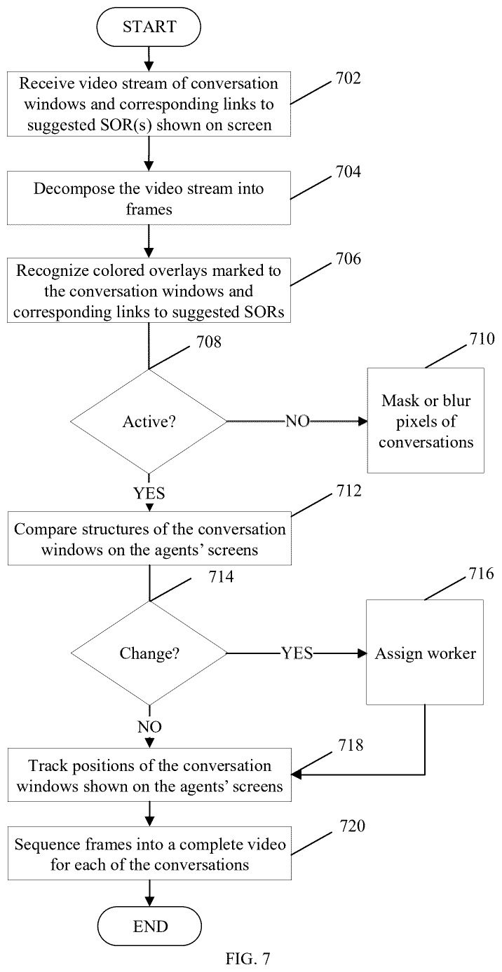

FIG. 7 is a schematic flowchart showing one or more example methods associated with recording, in real-time, a screen at a customer service center agent's computing device. The processing may comprise decomposing a video stream of a customer service center agent's screen into frames, segregating the frames based on statuses of conversations shown on the customer service center agent's screen, and sequencing frames associated with each active conversation and corresponding links to SORs into a complete video recording in real-time.

In step 702, the video processor 116 of the real-time AI-based intelligent screen recording system 104 (e.g., as shown in FIG. 1) may receive video stream of conversations and corresponding links to the mapped SORs that are shown on a customer service center agent's screen. Step 702 may, for example, comprise (or be comprised by) step 330 of FIG. 3B.

In step 704, the video processor 116 may decompose the video stream at frame level, for example, decompose the video stream into frames. Step 704 may, for example, comprise (or be comprised by) step 332 of FIG. 3C.

In step 706, the video processor 116 may recognize colored overlays that are marked to conversations and corresponding links to the mapped SORs. For example, green overlays may be used to mark active conversations and corresponding links to the mapped SORs. Step 706 may, for example, comprise (or be comprised by) step 334 of FIG. 3C.

In step 708, the video processor 116 may determine whether a conversation and corresponding links to the mapped SORs are active based on the colored overlays. For example, the video processor 116 may determine that a conversation and corresponding links to the mapped SORs is active if they are marked with green overlays. The video processor 116 may proceed with step 710 if the video processor 116 determines that a conversation and corresponding links to the mapped SOR is inactive. The video processor 116 may proceed with step 712 if the video processor 116 determines that a conversation and corresponding links to the mapped SORs is active. Step 708 may, for example, comprise (or be comprised by) step 336 of FIG. 3C.

In step 710, the video processor 116 may mask and/or blur pixels of inactive conversations and corresponding links to the mapped SORs if the video processor 116 determines the conversations ae inactive. Step 710 may, for example, comprise (or be comprised by) step 336 of FIG. 3C.

In step 712, the video processor 116 may determine to record conversations and corresponding links to the mapped SORs if the video processor 116 determines the conversations are active. In that case, the video processor 116 may compare structures of active conversation windows that are shown on the customer service center agent's screen to determine whether there are any changes to positions of the active conversation windows shown on the customer service center agent's screen. As such, active conversation windows shown on the customer service center agent's screen may be located and tracked for recording/sequencing. Step 712 may, for example, comprise (or be comprised by) step 338 of FIG. 3C.

In step 714, the video processor 116 may determine whether there is a change to positions of the active conversation windows shown on the customer service center agent's screen. The video processor 116 may proceed with step 716 if the video processor 116 determines that there is a change to positions of the active conversation windows shown on the customer service center agent's screen. The video processor 116 may proceed with step 718 if the video processor 116 determines that there is no change to positions of the active conversation windows shown on the customer service center agent's screen. Step 714 may, for example, comprise (or be comprised by) step 338 of FIG. 3C.

In step 716, the video processor 116 may assign a new worker/a new frame sequencer to an active conversation window for recording/sequencing if the number of the active conversation windows changes (e.g., from 3 active conversation windows to 2 or 4 active conversation windows), and accordingly, positions of the active conversation windows shown on the agent's screen change. The video processor 116 may proceed with step 718 after completing assigning a new worker/a new frame sequencer. Step 716 may, for example, comprise (or be comprised by) step 340 of FIG. 3C.

In step 718, the video processor 116 may track positions of the active conversation windows on the agent's screen if the number of the active conversation windows remains (e.g., 3 active conversation windows), and accordingly, positions of the active conversation windows shown on the agent's screen remain. Step 718 may, for example, comprise (or be comprised by) step 342 of FIG. 3C.

In step 720, the video processor 116 may sequence frames associated with the active conversations and corresponding links to the mapped SORs into a complete video for each active conversation, and further, store the complete video. Step 720 may, for example, comprise (or be comprised by) step 344 of FIG. 3C.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method for recording conversations of one or more agents of a customer service center during interactions with one or more customers of the customer service center, comprising:
receiving, by a computing platform having one or more processors, one or more conversations between the one or more agents of the customer service center and the one or more customers of the customer service center;
determining, for each conversation of the one or more conversations, a context of a respective conversation;
mapping, based on the determined contexts of each conversation of the one or more conversations, each conversation of the one or more conversations to one or more systems of record (SORs);
popping up one or more links to the mapped one or more SORs on computing device screens through which the one or more agents interact during the one or more conversations with the one or more customers;
determining, for each conversation of the one or more conversations, a status of the respective conversation;
generating, based on the determined status of each conversation of the one or more conversations, one or more colored overlays associated with each conversation;
displaying the one or more links and corresponding conversations shown on the screens with the one or more colored overlays; and
recording, based on the status of each conversation indicated by the colored overlay, the one or more conversations.

2. The method of claim 1, wherein the mapping further comprises:
identifying an identity of each of the one or more conversations.

3. The method of claim 1, wherein the popping up comprises:
retrieving user interface (UI) sources from a database;
converting UI sources written in different languages into one format;
building, based on the converted UI sources in one format, a structure of a UI image for showing each of the one or more links to the mapped one or more SORs on the screens; and
estimating a boundary of the structure of the UI image for showing each of the one or more links to the mapped one or more SORs on the screens.

4. The method of claim 1, wherein the generating further comprises:
distinguishing colors for the determined statuses of the one or more conversations;
tracking events associated with the one or more agents; and
generating, based on the distinguished colors and the tracked events, the one or more colored overlays.

5. The method of claim 1, wherein the displaying further comprises highlighting the one or more links and corresponding conversations shown on the screens.

6. The method of claim 1, wherein the recording further comprises:
decomposing the one or more conversations into frames; and
masking pixels of conversations, of the one or more conversations, whose statuses are inactive.

7. The method of claim 1, wherein the recording further comprises:
segregating the one or more conversations at frame level; and
sequencing conversations, of the one or more conversations, whose statuses are active, to generate a video of each of the conversations.

8. A computing platform for recording conversations of one or more agents of a customer service center during interactions with one or more customers of the customer service center, comprising:
at least one processor;
a communication interface communicatively coupled to the at least one processor; and emory storing computer-readable instructions that, when executed by the at least one processor, cause the computing platform to:
receive one or more conversations between the one or more agents of the customer service center and the one or more customers of the customer service center;
determine, for each conversation of the one or more conversations, a context of a respective conversation;
map, based on the determined contexts of each conversation of the one or more conversations, each conversation of the one or more conversations to one or more systems of record (SORs);
pop up one or more links to the mapped one or more SORs on computing device screens through which the one or more agents interact during the one or more conversations with the one or more customers;
determine, for each conversation of the one or more conversations, a status of the respective conversation;
generate, based on the determined status of each conversation of the one or more conversations, one or more colored overlays associated with each conversation;
display the one or more links and corresponding conversations shown on the screens with the one or more colored overlays; and
record, based on the status of each conversation indicated by the colored overlay, the one or more conversations.

9. The computing platform of claim 8, wherein the computer-readable instructions further cause the computing platform to:
identify an identity of each of the one or more conversations.

10. The computing platform of claim 8, wherein the computer-readable instructions further cause the computing platform to:
retrieve user interface (UI) sources from a database;
convert UI sources written in different languages into one format;
build, based on the converted UI sources in one format, a structure of a UI image for showing each of the one or more links to the mapped one or more SORs on the screens; and
estimate a boundary of the structure of the UI image for showing each of the one or more links to the mapped one or more SORs on the screens.

11. The computing platform of claim 8, wherein the computer-readable instructions further cause the computing platform to:
distinguish colors for the determined statuses of the one or more conversations;
track events associated with the one or more agents; and
generate, based on the distinguished colors and the tracked events, the one or more colored overlays.

12. The computing platform of claim 8, wherein the computer-readable instructions further cause the computing platform to:
highlight the one or more links and corresponding conversations shown on the screens.

13. The computing platform of claim 8, wherein the computer-readable instructions further cause the computing platform to:
decompose the one or more conversations into frames; and
mask pixels of conversations, of the one or more conversations, whose statuses are inactive.

14. The computing platform of claim 8, wherein the computer-readable instructions further cause the computing platform to:
segregate the one or more conversations at frame level; and
sequence conversations, of the one or more conversations, whose statuses are active, to generate a video of each of the conversations.

15. A non-transitory computer-readable medium, having computer-executable instructions stored thereon, the computer-executable instructions, when executed by one or more processors of a computing platform for recording conversations of one or more agents of a customer service center during interactions with one or more customers of the customer service center, cause the computing platform to facilitate:
receiving one or more conversations between the one or more agents of the customer service center and the one or more customers of the customer service center;
determining, for each conversation of the one or more conversations, a context of a respective conversation;
mapping, based on the determined contexts of each conversation of the one or more conversations, each conversation of the one or more conversations to one or more systems of record (SORs);
popping up one or more links to the mapped one or more SORs on computing device screens through which the one or more agents interact during the one or more conversations with the one or more customers;
determining, for each conversation of the one or more conversations, a status of the respective conversation;
generating, based on the determined status of each conversation of the one or more conversations, one or more colored overlays associated with each conversation;
displaying the one or more links and corresponding conversations shown on the screens with the one or more colored overlays; and
recording, based on the status of each conversation indicated by the colored overlay, the one or more conversations.

16. The non-transitory computer-readable medium of claim 15, wherein the computer-executable instructions further cause the computing platform to facilitate:
identifying an identity of each of the one or more conversations.

17. The non-transitory computer-readable medium of claim 15, wherein the computer-executable instructions further cause the computing platform to facilitate:
retrieving user interface (UI) sources from a database;
converting UI sources written in different languages into one format;
building, based on the converted UI sources in one format, a structure of a UI image for showing each of the one or more links to the mapped one or more SORs on the screens; and
estimating a boundary of the structure of the UI image for showing each of the one or more links to the mapped one or more SORs on the screens.

18. The non-transitory computer-readable medium of claim 15, wherein the computer-executable instructions further cause the computing platform to facilitate:
distinguishing colors for the determined statuses of the one or more conversations;
tracking events associated with the one or more agents; and
generating, based on the distinguished colors and the tracked events, the one or more colored overlays.

19. The non-transitory computer-readable medium of claim 15, wherein the computer-executable instructions further cause the computing platform to facilitate:
decomposing the one or more conversations into frames; and
masking pixels of conversations, of the one or more conversations, whose statuses are inactive.

20. The non-transitory computer-readable medium of claim 15, wherein the computer-executable instructions further cause the computing platform to facilitate:
segregating the one or more conversations at frame level; and
sequencing conversations, of the one or more conversations, whose statuses are active, to generate a video of each of the conversations.
